(19) United States
(12) Patent Application Publication
(10) Pub. No.: US 2026/0193929 A1
(43) Pub. Date: Jul. 9, 2026

(54) REINFORCED LOCKING MECHANISM

(71) Applicant: LiveView Technologies, LLC, American Fork, UT (US)

(72) Inventors: Jordan SMITH, Spanish Fork, UT (US); Nathan B. SWENA, American Fork, UT (US); Riley J. HIATT, American Fork, UT (US)

(21) Appl. No.: 19/206,720

(22) Filed: May 13, 2025

Related U.S. Application Data
(60) Provisional application No. 63/741,588, filed on Jan. 3, 2025.

(51) Int. Cl. E05G 1/00; E05G 1/04; F21V 23/00

(52) U.S. Cl. CPC E05G 1/005; E05G 1/04; F21V 23/008

(57) ABSTRACT

A device may include a frame. A device may include a lid movable relative to the frame at a first edge of the lid. A device may include a striker affixed to the lid proximate to the first edge, wherein the striker includes: a contact element, and a reinforcement element coupled to the lid, wherein the contact element is positioned between the reinforcement element and the lid. A device may include a latch mechanism connected to the frame and configured to selectively engage with the contact element.

### CROSS-REFERENCE TO RELATED APPLICATIONS

This application claims priority to and the benefit of U.S. Provisional Patent Application No. 63/741,588, filed on Jan. 3, 2025, which is hereby incorporated by reference in its entirety.

### TECHNICAL FIELD

This disclosure relates generally to securely locking a container for a mobile security system, and to associated devices, systems, units, and containers.

### BACKGROUND

Remote security systems include a power supply, a computing device, and one or more sensors in a self-contained unit. The unit allows an operator or technician to deploy the unit in a remote location without an existing infrastructure, such as external electrical sources or hard-wired communication systems. By the nature of being a self-contained and remote security system, the unit can become a target for theft and vandalism, itself, requiring locking mechanisms to secure the components of the unit.

### BRIEF SUMMARY

In some aspects, the techniques described herein relate to a secure container including: a frame; a lid movable relative to the frame at a first edge of the lid; a striker affixed to the lid proximate to the first edge, wherein the striker includes: a contact element, and a reinforcement element coupled to the lid, wherein the contact element is positioned between the reinforcement element and the lid; and a latch mechanism connected to the frame and configured to selectively engage with the contact element.

In some aspects, the techniques described herein relate to a system for remote security, the system including: a trailer; and a storage box supported by the trailer, the storage box including: a body contained at least one computing device, a lid movable relative to the body at a first edge of the lid, a striker affixed to the lid proximate to the first edge, wherein the striker includes: a contact element, and a reinforcement element coupled to the lid, wherein the contact element is positioned between the reinforcement element and the lid and at least a portion of the contact element is positioned within a window in the reinforcement element, and a latch mechanism connected to the body and configured to selectively engage with the contact element.

In some aspects, the techniques described herein relate to a system for remote security, the system including: a trailer; a storage box supported by the trailer, the storage box including: a body contained at least one computing device, a lid movable relative to the body at a first edge of the lid, a striker affixed to the lid proximate to the first edge, wherein the striker includes: a contact element, and a reinforcement element coupled to the lid, wherein the contact element is positioned between the reinforcement element and the lid and at least a portion of the contact element is positioned within a window in the reinforcement element, and a latch mechanism connected to the body and configured to selectively engage with the contact element; a mast connected to the trailer or the storage box at a first end of the mast; and a head unit supported by the mast at a second end of the mast, wherein at least one electronic component of the head unit is in data communication with the at least one computing device of the storage box.

In some aspects, the techniques described herein relate to any device, system, unit, container, method, or kit described herein.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a perspective view of a mobile security unit, in accordance with various embodiments of the disclosure.

FIG. 2 is a detail view of a storage box, in accordance with various embodiments of the disclosure.

FIG. 3 is a perspective view of a lid including a reinforced striker configured to be received by and retained by a latching mechanism, in accordance with various embodiments of the disclosure.

FIG. 4 is a transverse cross-sectional view of a lid with a reinforced striker, in accordance with various embodiments of the disclosure.

FIG. 5 is a top view of a reinforced striker, in accordance with various embodiments of the disclosure.

FIG. 6 is a top view of another reinforced striker, in accordance with various embodiments of the disclosure.

### DETAILED DESCRIPTION

The present disclosure relates generally to improved security for remote monitoring or security systems and devices. More particularly, mobile security and monitoring systems and devices are, by the nature of their purpose, deployed in locations away from buildings or other secure locations. As such, the mobile security systems and devices can, themselves become targets for damage or theft. In some examples, the mobile security systems and devices are deployed in locations with adverse weather or other environmental conditions. In such examples, added rigidity, security and sealing of the mobile security systems and devices can improve the operational lifetime of the mobile security systems and devices.

In some embodiments, mobile security systems and devices according to the present disclosure include a reinforced striker on a closure system. For example, a lid or other portion of a storage box may be targeted for damage or theft by prying or lifting the lid relative to a body of the storage box. In some embodiments, a reinforced striker provides additional contact surfaces for additional welding or other bonding between the striker and the lid. In some embodiments, a reinforced striker provides additional rigidity to the lid or other portion of the storage box to which it is affixed, further limiting the susceptibility of the mobile security system to intrusion.

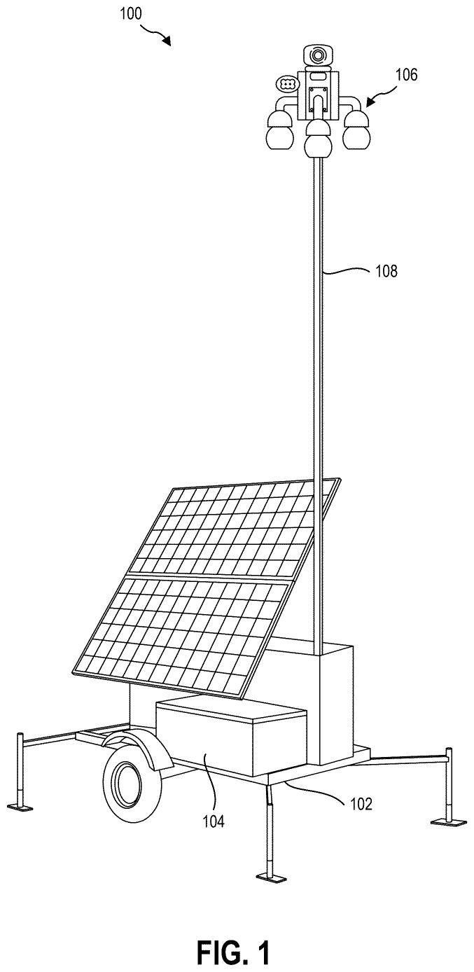

FIG. 1 is a perspective view of an embodiment of a unit 100, in accordance with various embodiments of the disclosure. The unit 100, which may also be referred to herein as a “mobile unit,” a “mobile surveillance unit,” a “mobile security unit,” an “MSU,” a “live unit,” or a “physical unit,” may be configured to be positioned in an environment (e.g., a parking lot, a roadside location, a construction zone, a concert venue, a sporting venue, a school campus, without limitation). In some embodiments, the unit 100 includes one or more sensors (e.g., cameras, weather sensors, motion sensors, noise sensors, without limitation) and one or more output devices (e.g., lights, speakers, electronic displays, without limitation). The unit 100 may also include at least one storage device (e.g., internal flash media, a network attached storage device, or any other suitable electronic storage device), which may be configured for receiving and storing data (e.g., video, images, audio, without limitation) captured by one or more sensors of the unit 100.

In some embodiments, the unit 100 includes a mobile security unit. In these and other embodiments, the unit 100 may include a portable trailer 102, a storage box 104, and a mast 108 coupled to a head unit 106 which may include for example, one or more batteries, one or more cameras, one or more lights, one or more speakers, and/or one or more microphones. According to some embodiments, a first end of the mast 108 may be proximate to the storage box 104 and a second, opposite end of the mast 108 may be proximate, and possibly adjacent, to the head unit 106. More specifically, in some embodiments, head unit 106 may be coupled to the mast 108 at an end opposite to an end of the mast 108 proximate to the storage box 104.

In some examples, the unit 100 may include one or more primary batteries (e.g., within the storage box 104) and one or more secondary batteries (e.g., within the head unit 106). In these embodiments, a primary battery positioned in storage box 104 may be coupled to a load and/or a secondary battery positioned within head unit 106 via, for example, a cord reel.

In some embodiments, the unit 100 includes at least one computing device and/or other electronics powered by the one or more batteries. In some embodiments, the at least one computing device and/or other electronics are securely housed in the storage box 104 and in data communication with the head unit 106. For example, a head unit 106 may include one or more sensors or one or more output devices, and the computing device may receive data from the one or more sensors and/or transmit instructions to the one or more output devices. As described above, in some embodiments, the storage box 104 securely houses one or more hardware storage devices. The one or more storage devices may be in data communication with and/or integrated with the one or more computing devices.

In some embodiments, the unit 100 may also include one or more power sources and/or power supplies. For example, the unit 100 may include or be in electrical communication with one or more solar panels 109, which may provide power to one or more batteries of unit. More specifically, according to some embodiments, one or more solar panels 109 may provide power to a primary battery within storage box 104. In some embodiments, the unit 100 may also include other power sources, such as one or more generators (e.g., fuel cell generator, fossil fuel generator), wind turbines, etc. For example, storage box 104 may include a fuel cell generator and/or another power generator.

During transport or storage of the unit 100, one or more components of the unit 100 may be removed from the unit 100, the mast 108, or the head unit 106. In some embodiments, the mast 108 is an extendable or deployable mast and the mast 108 is extended or deployed at the time of deployment of the unit 100 in a field location. For example, the mast 108 may be connected to the trailer 102 and/or storage box 104 at a first end of the mast 108, and the head unit 106 may be positioned at an elevated position at the second end of the mast 108 upon deployment of the unit 100. In some embodiments, the head unit 106 includes one or more sensors (e.g., cameras, weather sensors, motion sensors, noise sensors, without limitation) and one or more output devices (e.g., lights, speakers, electronic displays, without limitation) that are affixed to the head unit 106 upon deployment. In some embodiments, the head unit 106 is positioned on the second end of the mast 108 prior to an electronic component (such as one or more sensors and/or one or more output devices) being connected thereto. In particular examples, the unit 100 is deployed in a remote location, a poorly lit location, or at location with limited assembly resources (such as ladders or other platforms from which a technician can work). In some examples, selected sensors (e.g., cameras and/or other sensor) and/or output devices may be stored in the storage box 104 and/or remain in the storage box 104 during storage, transport, and/or deployment. Security of the storage box 104 is, therefore, paramount for the unit 100.

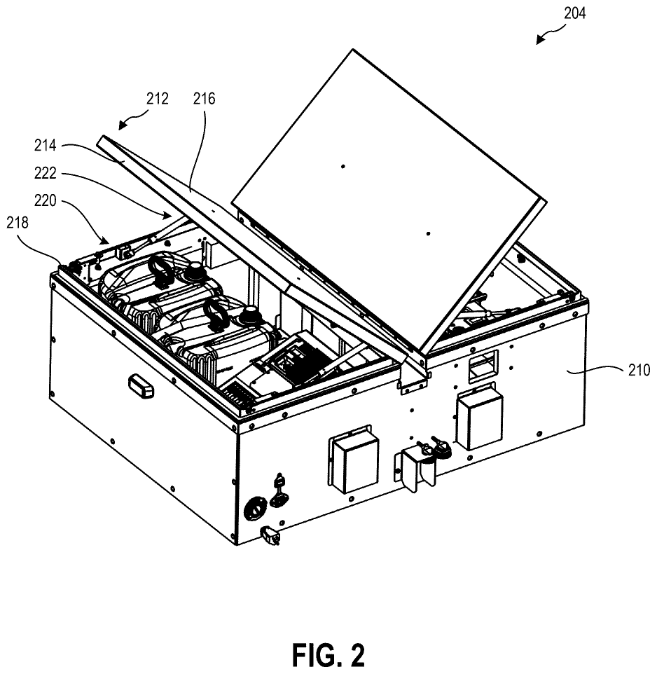

FIG. 2 is a detailed view of an embodiment of a storage box 204 according to a least some embodiments of the present disclosure. The storage box 204 has a body 210 and a lid 212 that is moveable relative to the body 210. In some embodiments, the lid 212 has a lip 214 that protrudes from a main sheet 216 of the lid 212 toward the body 210 when in a closed configuration. In some embodiments the lip 214 contacts the body 210 in a closed configuration. In some embodiments, the lip 214 overlaps or overhangs a portion of the body 210 and the main sheet 216 of the lid 212 contacts the body 210. In some embodiments, the lip 214 overlaps or overhangs a portion of the body 210 with a gasket or other type of sealing element to limit and/or prevent contaminants or moisture from entering the storage box 204. In some embodiments, a gasket or other type of sealing element in affixed to the main sheet 216 of the lid 212 to limit and/or prevent contaminants or moisture from entering the storage box 204.

In some examples, in the closed configuration, the edges of the lid 212 contact the body 210, and the storage box 204 is closed. In some embodiments, the storage box 204 has a latched configuration in which the storage box 204 is in a closed configuration and a latch mechanism 218 is engaged with the lid 212 to secure the lid 212 in the closed configuration. In some embodiments, the storage box 204 may be in a closed configuration while remaining unlatched. In some embodiments, the storage box 204 is in an open configuration when at least a portion of an opening 220 of the body 210 is not contacting the lid 212.

In some embodiments, the lid 212 is connected to the body 210 by a hinge 222. In some embodiments, the lid 212 is detachable from the body 210 entirely in an open configuration (e.g., no hinge connection). In some embodiments, the lid 212 is selectively connected to the body 210 by a first latching mechanism 218 and a second latching mechanism opposite the first latching mechanism 218, where the lid 212 is rotatably connected (such as in a hinge) when only one of the two latching mechanisms is engaged. Such a configuration may allow the lid 212 to remain connected (such as by maintaining a connection at the second latching mechanism) during field use, and the configuration may allow the lid 212 to fully lift off (such as by disengaging both the first latching mechanism 218 and the second latching mechanism) during maintenance or assembly. In some embodiments, the storage box 204 includes two lids, as shown in FIG. 2.

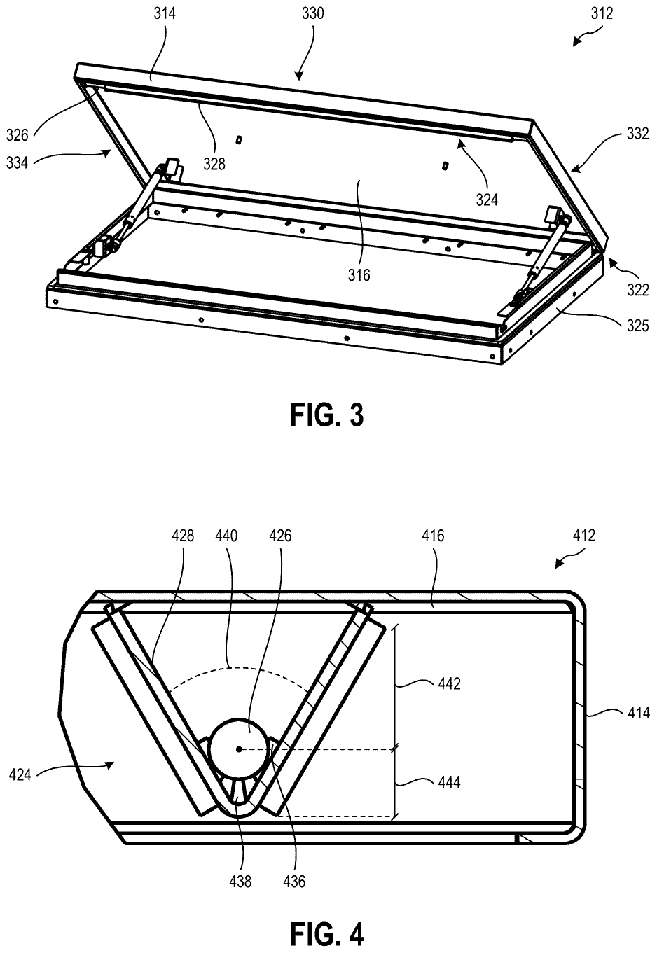

As described herein, the storage box 204 may be targeted for theft or vandalism, and a reinforcement of the closure mechanism between the lid 212 and the body 210 may provide security by strengthening the retention of the lid 212 in the latched configuration and/or by providing additional rigidity and reinforcement to the lid 212 itself. FIG. 3 is a perspective view of a lid 312 including a reinforced striker 324 configured to be received by and retained by a latching mechanism. In some embodiments, the lid 312 is connected to a frame 325 by a hinge 322. In some embodiments, the frame 325 is configured to fasten, adhere, bond, or otherwise connect to a body (such as a body 210) of a storage box. In some embodiments, the frame 325 is integrally formed with a body of a storage box, where the hinge 322 connects the lid 312 to the body of the storage box (such as illustrated in the embodiment of FIG. 2). In some embodiments, the reinforced striker 324 includes a contact element 326 within a reinforcement element 328. The contact element 326 is received by and retained by a latching mechanism (such as the latching mechanism 218 described in relation to FIG. 2), while the reinforcement element 328 provides additional support to and increased bonding surface area between the contact element 326 and the lid 312. In some embodiments, the reinforcement element 328 is coupled to the lid 312 and the contact element 326 is between the lid 312 and the reinforcement element 328. In some embodiments, the latching mechanism is coupled to and/or integrated with the frame 325. In some embodiments, the latching mechanism is coupled to and/or integrated with a body of a storage box to which the frame 325 connects.

In some embodiments, the reinforced striker 324 is affixed directly to the main sheet 316 of the lid 312. In some embodiments, the reinforced striker 324 is affixed directly to the main sheet 316 of the lid 312 proximate to a first edge 330 of the lid 312. For example, the first edge 330 may be located opposite the hinge 322 of the lid 312. In some examples, the first edge 330 may be located opposite a second reinforced striker 324 for retaining the lid 312 on a storage box. In some embodiments, the lid 312 is movable relative to the frame 325 at least at the first edge of the lid 312.

In some embodiments, the reinforced striker 324 is welded to the main sheet 316 of the lid 312. In some embodiments, the reinforced striker 324 is adhered to the main sheet 316 of the lid 312 with an adhesive. In some embodiments, the reinforced striker 324 is mechanically fastened (e.g., by rivet(s), bolt(s), screw(s)) to the main sheet 316 of the lid 312. In some embodiments, the reinforced striker 324 is affixed to the main sheet 316 of the lid 312 by a combination of welding, adhering, or mechanical fastening. In some embodiments, the reinforced striker 324 is affixed to the lid 312 along a full length of the reinforced striker 324. In some embodiments, the reinforced striker 324 is affixed to the lid 312 at select locations (such as tack welds) along a length of the reinforced striker 324 that is/are less than the full length of the reinforced striker 324. In some embodiments, the reinforced striker 324 is substantially continuous along and/or is affixed to the lid 312 along at least 80% of a length of the first edge 330 of the lid 312. In some embodiments, the reinforced striker 324 is substantially continuous along and/or is affixed to the lid 312 along at least 60% of a length of the first edge 330 of the lid 312. In some embodiments, the reinforced striker 324 is substantially continuous along and/or is affixed to the lid 312 along at least 50% of a length of the first edge 330 of the lid 312. In some embodiments, a longitudinal axis of the reinforced striker 324 is substantially parallel to a longitudinal axis of the hinge 322.

In some embodiments, the reinforced striker 324 is affixed directly to a lip 314 of the lid 312. In some embodiments, the reinforced striker 324 is affixed directly to the lip 314 of the lid 312 proximate to a first edge 330 of the lid 312. For example, the first edge 330 may be located opposite the hinge 322 of the lid 312. In some examples, the first edge 330 may be located opposite a second reinforced striker 324 for retaining the lid 312 on a storage box.

In some embodiments, the reinforced striker 324 is welded to the lip 314 of the lid 312. In some embodiments, the reinforced striker 324 is adhered to the lip 314 of the lid 312 with an adhesive. In some embodiments, the reinforced striker 324 is mechanically fastened (e.g., by rivet(s), bolt(s), screw(s)) to the lip 314 of the lid 312. In some embodiments, the reinforced striker 324 is affixed to the lip 314 of the lid 312 by a combination of welding, adhering, or mechanical fastening. In some embodiments, the reinforced striker 324 is affixed to the lip 314 along a full length of the reinforced striker 324. In some embodiments, the reinforced striker 324 is affixed to the lip 314 at select locations (such as tack welds) along a length of the reinforced striker 324 that is/are less than the full length of the reinforced striker 324.

In some embodiments, the reinforced striker 324 is affixed directly to the main sheet 316 and to a lip 314 of the lid 312. In some embodiments, the reinforced striker 324 is affixed directly to the main sheet 316 and to both lips 314 of the lid 312 at either longitudinal end of the reinforced striker 324. In some embodiments, the reinforced striker 324 is welded to at least one of the lip 314 and the main sheet 316 of the lid 312 and affixed to the other of the lip 314 and the main sheet 316. In some embodiments, the reinforced striker 324 is adhered to at least one of the lip 314 and the main sheet 316 of the lid 312 with an adhesive and affixed to the other of the lip 314 and the main sheet 316. In some embodiments, the reinforced striker 324 is mechanically fastened (e.g., by rivet(s), bolt(s), screw(s)) to at least one of the lip 314 and the main sheet 316 of the lid 312 and affixed to the other of the lip 314 and the main sheet 316. In some embodiments, the reinforced striker 324 is affixed to at least one of the lip 314 and the main sheet 316 of the lid 312 and affixed to the other of the lip 314 and the main sheet 316 by a combination of welding, adhering, or mechanical fastening. In at least one embodiment, the reinforced striker 324 is welded to the main sheet 316 proximate to a first edge 330, welded to a lip 314 proximate to a second edge 332 at a first longitudinal end of the reinforced striker 324, and welded to a lip 314 proximate to a third edge 334 at a second longitudinal end of the reinforced striker 324.

FIG. 4 is a transverse cross-sectional view of an embodiment of a lid 412 with a reinforced striker 424. The reinforced striker 424 is affixed to the main sheet 416 of the lid 412 proximate to a lip 414. In some embodiments, the reinforced striker 424 includes a contact element 426 positioned between the reinforcement element 428 and the main sheet 416 or other portion of the lid 412 to which the reinforced striker 424 is affixed. In some embodiments, the contact element 426 is affixed to the reinforcement element 428. In some examples, the contact element 426 is welded to the reinforcement element 428. In some examples the contact element 426 is adhered to the reinforcement element 428. In some examples, the contact element 426 is affixed to the reinforcement element 428 by one or more mechanical fasteners. In some examples, the contact element 426 is affixed to the reinforcement element 428 by a combination of the foregoing. In at least one embodiment, the contact element 426 is movable relative to the reinforcement element 428, such as being freely floating between the reinforcement element 428 and the lid 412. In such examples, the contact element 426 may be free to move independently from the lid 412 such that a strike or other force applied downward to the lid 412 cannot crack or damage the weld or other bond between the contact element 426 and the reinforcement element 428.

In some embodiments, the contact element 426 is affixed to the reinforcement element 428 in at least one location. In some embodiments, the contact element 426 is affixed to the reinforcement element 428 in at least two locations. In some embodiments, the contact element 426 is located relative to the reinforcement element 428 by one or more spacers 436, 438. For example, the location of the contact element 426 relative to the reinforcement element 428 may be based at least partially on a diameter of the contact element 426 and an internal angle 440 of the reinforcement element 428. The contact element 426 may settle into a V-shaped channel of the reinforcement element 428 for fixation to the reinforcement element 428 at a height based on the internal angle 440. In some embodiments, one or more spacers 436, 438 can adjust the ratio of the contact element height 442 (distance from the contact region with the lid 412 to the center axis of the contact element 426) relative to the reinforcement element height 444 (distance from the contact region with the lid 412 to the farther point of the reinforcement element 428). The latch mechanism of the storage box and/or frame may be configured to receive the contact element 426 at an expected height, while the reinforcement element 428 may be limited in height for a required clearance.

In some embodiments, the internal angle 440 is in a range having an upper value, a lower value, or upper and lower values including any of 30°, 40°, 50°, 60°, 70°, 80°, 90°, 100°, 110°, 120°, or any values therebetween. In some examples, the internal angle 440 is greater than 30°. In some examples, the internal angle 440 is less than 120°. In some examples, the internal angle 440 is between 30° and 120°. In some examples, the internal angle 440 is between 40° and 90°. In some examples, the internal angle 440 is between 50° and 70°. In at least one example, the internal angle 440 is approximately 60°. While the larger angles may provide more clearance for the contact element 426, as well as welds and other manufacturing needs, the larger angles may create stress risers when force is applied to the contact element 426. The smaller angles may place any tension forces applied to the reinforced striker 424 in a more direct tension with the welds with the lid 412, but the smaller angles leave less available space for the contact element 426.

In some embodiments, the contact element 426 has a cross-sectional shape that is or includes a circle, an ellipse, an oval, a triangle, a rectangle, a pentagon, an octagon, any other regular polygonal shape, an irregular polygonal shape, or combinations thereof to provide sufficient contact surface between the contact element 426 and the reinforcement element 428 for fixation of the contact element 426 to the reinforcement element 428.

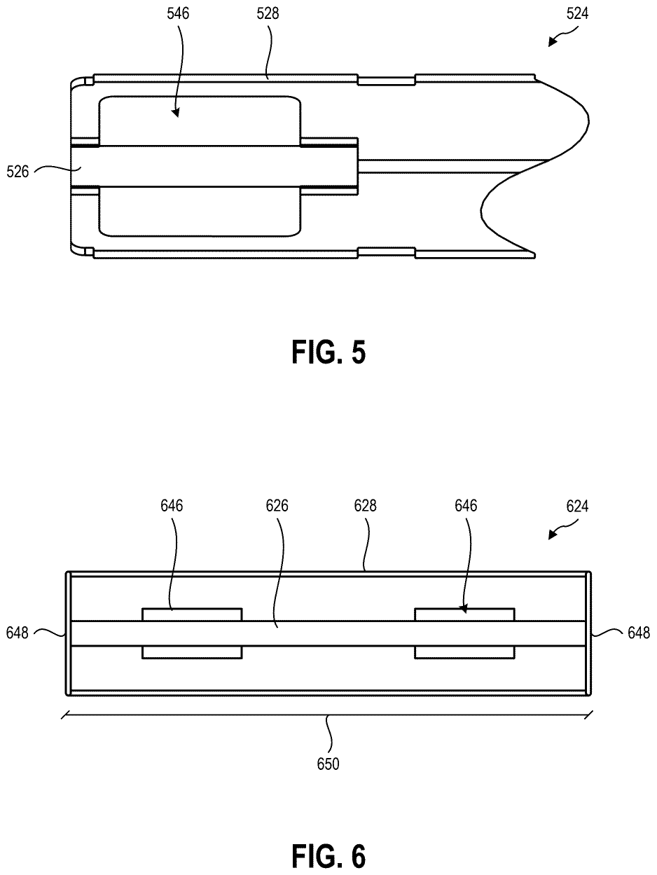

FIG. 5 is a top view (e.g., viewed from the side oriented toward the lid) of an embodiment of a reinforced striker 524. In some embodiments, the contact element 526 is located in a window 546 of the reinforcement element 528. In some embodiments, the contact element 526 is fixed to the reinforcement element 528 on both longitudinal ends of the window 546. For example, fixation of the contact element 526 at both longitudinal ends of the window 546 may ensure alignment of the contact element 526 with repeated use and provide additional strength to the bond between the contact element 526 and the reinforcement element 528. In some embodiments, the contact element 526 is only fixed to the reinforcement element 528 on one longitudinal end of the window 546. For example, the contact element 526 experiences greatest force in a direction against the reinforcement element 528, such as during an attempt to pull the lid off of a storage box. Additional welds between the contact element 526 and the reinforcement element 528 may not be necessary.

In some embodiments, the reinforced striker 524 includes a plurality of windows 546 in the reinforcement element 528. In some embodiments, the reinforced striker 524 includes a discrete and separate contact element 526 positioned in each of the windows 546. In some embodiments, the reinforced striker 524 may include a plurality of windows 546 to provide compatibility of a single part with a plurality of storage box and/or frame designs, while a contact element 526 is only affixed in some of the windows 546 but not all of the windows 546.

The window 546 may have any shape that allows a latch mechanism to engage with and latch to the contact element 526. In some embodiments, the window 546 is symmetrical in a longitudinal direction of the reinforcement element 528. In such examples, the reinforcement element 528 may be symmetrical, which simplifies manufacturing processes. In some embodiments, the window 546 is asymmetrical in the longitudinal direction. Such examples may provide centering assistance upon closing the lid when the reinforcement element 528 contacts the latch mechanism or other portion of the frame and/or storage box. In some embodiments, the window 546 is symmetrical in a transverse direction of the reinforcement element 528. In such examples, the reinforcement element 528 may be symmetrical, which simplifies manufacturing processes. In some embodiments, the window 546 is asymmetrical in the transverse direction. Such examples may provide alignment assistance upon closing the lid when the reinforcement element 528 contacts the latch mechanism or other portion of the frame and/or storage box.

FIG. 6 is a top view of another embodiment of a reinforced striker 624 including windows 646. In some embodiments, a window 646 is asymmetrical in the transverse direction with more material of a reinforcement element 628 on the transverse side oriented toward the edge of the lid. In such examples, the window 646 may be more difficult for a pry bar or other tool to be inserted into, which may increase the security of the storage box.

In some embodiments, the reinforced striker 624 includes a plurality of windows 646 with a single, monolithic contact element 626 positioned in at least two of the windows 646, and the contact element 626 is substantially continuous along a longitudinal distance therebetween. In some embodiments, the reinforced striker 624 includes a single, monolithic reinforcement element 628 with a plurality of windows 646 that is substantially continuous therebetween, and a single, monolithic contact element 626 is positioned in at least two of the windows 646 and spanning a longitudinal distance substantially continuously therebetween. In some examples, the contact element 626 may be fixed to the reinforcement element 628 proximate to each of the windows 646. In some examples, the contact element 626 may be fixed to the reinforcement element 628 on both ends of each window 646.

In some embodiments, the contact element 626 is fixed to (e.g., welded to) the reinforcement element 628 along a full longitudinal length of the contact element 626. In some embodiments, the contact element 626 is fixed to (e.g., welded to) the reinforcement element 628 along a full longitudinal length 650 of the reinforcement element 628. In some embodiments, the reinforcement element 628 further includes an end cap 648 at one or both longitudinal ends of the reinforcement element 628. In such examples, the contact element 626 may be fixed to the end cap 648. In at least one embodiment, the contact element 626 is fixed to the reinforcement element 628 along a full longitudinal length 650 of the reinforcement element 628 and to both end caps 648. In some embodiments, the end cap 648 is integrally formed with and/or part of a lip of the lid. For example, the reinforcement element 628 may be welded to the lid (e.g., a main sheet of the lid) along at least a portion of the longitudinal length 650 of the reinforcement element 628, and the contact element 626 and/or the reinforcement element 628 may be further welded to an adjacent lip (e.g., a lip adjacent to the main sheet) of the lid. Welding or other fixation of the reinforced striker to two surfaces of the lid may be further strengthen the lid.

In at least one embodiment according to the present disclosure, a closure mechanism for a storage box includes a reinforced striker that improves security of the storage box with a compact and easily manufactured design according to any of the embodiments described herein. In at least one example, a reinforced striker provides an increase contact area between the striker and the lid to strengthen the connection therebetween. In at least one example, a reinforced striker according to the present disclosure provides increased rigidity of the lid to which it is coupled, further improving the security of the storage box by resisting prying and twisting of the lid.

The present disclosure relates to latching mechanisms and secure storage boxes according to at least the following clauses:

Clause 1. A secure container comprising: a frame; a lid movable relative to the frame at a first edge of the lid; a striker affixed to the lid proximate to the first edge, wherein the striker includes: a contact element, and a reinforcement element coupled to the lid, wherein the contact element is positioned between the reinforcement element and the lid; and a latch mechanism connected to the frame and configured to selectively engage with the contact element.

Clause 2. The secure container of clause 1, wherein the reinforcement element includes a window opposite the lid, and the contact element is positioned in the window of the reinforcement element.

Clause 3. The secure container of clause 2, wherein the window is a first window of the reinforcement element, and wherein the reinforcement element includes a second window and the contact element is continuous between the first window and the second window.

Clause 4. The secure container of clause 2, wherein the contact element is bonded to the reinforcement element along a full length of the contact element except for the window.

Clause 5. The secure container of clause 1, wherein the contact element is a monolithic element.

Clause 6. The secure container of clause 1, wherein the reinforcement element is a monolithic element.

Clause 7. The secure container of clause 1, wherein the reinforcement element is substantially continuous along at least 80% of a length of the first edge of the lid.

Clause 8. The secure container of clause 1, wherein the reinforcement element is substantially continuous along a full length of the first edge of the lid.

Clause 9. The secure container of clause 7, wherein the reinforcement element is further affixed to at least one of a first lip proximate a first longitudinal end of the reinforcement element and a second lip proximate a second longitudinal end of the reinforcement element.

Clause 10. The secure container of clause 1, wherein the reinforcement element is bonded to the lid along a full length of the reinforcement element.

Clause 11. The secure container of clause 1, wherein the contact element contacts the reinforcement element and the lid.

Clause 12. The secure container of clause 1, further comprising a spacer positioned between the contact element and the reinforcement element.

Clause 13. The secure container of clause 1, wherein the striker is a first striker, and further comprising a second striker affixed to the lid proximate to a second edge of the lid, wherein the second edge is opposite the first edge.

Clause 14. A system for remote security, the system comprising: a trailer; and a storage box supported by the trailer, the storage box including: a body contained at least one computing device, a lid movable relative to the body at a first edge of the lid, a striker affixed to the lid proximate to the first edge, wherein the striker includes: a contact element, and a reinforcement element coupled to the lid, wherein the contact element is positioned between the reinforcement element and the lid and at least a portion of the contact element is positioned within a window in the reinforcement element, and a latch mechanism connected to the body and configured to selectively engage with the contact element.

Clause 15. The system of clause 14, wherein the latch mechanism is selectively engaged by the at least one computing device.

Clause 16. The system of clause 14, wherein the body further contains a power source.

Clause 17. The system of clause 14, wherein the reinforcement element is welded to the lid along a full length of the first edge of the lid.

Clause 18. The system of clause 14, wherein the contact element is welded to the reinforcement element on both longitudinal sides of the window.

Clause 19. The system of clause 14, wherein the window is asymmetrical in a transverse direction relative to a longitudinal direction of the contact element.

Clause 20. A system for remote security, the system comprising: a trailer; a storage box supported by the trailer, the storage box including: a body contained at least one computing device, a lid movable relative to the body at a first edge of the lid, a striker affixed to the lid proximate to the first edge, wherein the striker includes: a contact element, and a reinforcement element coupled to the lid, wherein the contact element is positioned between the reinforcement element and the lid and at least a portion of the contact element is positioned within a window in the reinforcement element, and a latch mechanism connected to the body and configured to selectively engage with the contact element; a mast connected to the trailer or the storage box at a first end of the mast; and a head unit supported by the mast at a second end of the mast, wherein at least one electronic component of the head unit is in data communication with the at least one computing device of the storage box.

Clause 21. Any device, system, container, unit, method, or kit described herein.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method. In addition, in the accompanying figures, and unless otherwise described, similar elements are denoted by the same numerical designation, with the exception of the first digit. For example, element 1XX in one figure corresponds to element 2XX in another figure, highlighting their functional similarity. As a specific example, the reinforced striker 324 described with reference to FIG. 3 may be the same as the reinforced striker 424 described with reference to FIG. 4.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A secure container for a mobile security unit, the secure container comprising:
a frame;
a lid movable relative to the frame at a first edge of the lid;
a striker affixed to the lid proximate to the first edge, wherein the striker includes:
a contact element, and
a reinforcement element coupled to the lid, wherein the contact element is positioned between the reinforcement element and the lid; and
a latch mechanism connected to the frame and configured to selectively engage with the contact element.

2. The secure container of claim 1, wherein the reinforcement element includes a window opposite the lid, and the contact element is positioned in the window of the reinforcement element.

3. The secure container of claim 2, wherein the window is a first window of the reinforcement element, and wherein the reinforcement element includes a second window and the contact element is continuous between the first window and the second window.

4. The secure container of claim 2, wherein the contact element is bonded to the reinforcement element along a full length of the contact element except for the window.

5. The secure container of claim 1, wherein the contact element is a monolithic element.

6. The secure container of claim 1, wherein the reinforcement element is a monolithic element.

7. The secure container of claim 1, wherein the reinforcement element is substantially continuous along at least 80% of a length of the first edge of the lid.

8. The secure container of claim 1, wherein the reinforcement element is substantially continuous along a full length of the first edge of the lid.

9. The secure container of claim 8, wherein the reinforcement element is further affixed to at least one of a first lip proximate a first longitudinal end of the reinforcement element and a second lip proximate a second longitudinal end of the reinforcement element.

10. The secure container of claim 1, wherein the reinforcement element is bonded to the lid along a full length of the reinforcement element.

11. The secure container of claim 1, wherein the contact element contacts the reinforcement element and the lid.

12. The secure container of claim 1, further comprising a spacer positioned between the contact element and the reinforcement element.

13. The secure container of claim 1, wherein the striker is a first striker, and
further comprising a second striker affixed to the lid proximate to a second edge of the lid, wherein the second edge is opposite the first edge.

14. A system for remote security, the system comprising:
a trailer; and
a storage box supported by the trailer, the storage box including:
a body contained at least one computing device,
a lid movable relative to the body at a first edge of the lid,
a striker affixed to the lid proximate to the first edge, wherein the striker includes:
a contact element, and
a reinforcement element coupled to the lid, wherein the contact element is positioned between the reinforcement element and the lid and at least a portion of the contact element is positioned within a window in the reinforcement element, and
a latch mechanism connected to the body and configured to selectively engage with the contact element.

15. The system of claim 14, wherein the latch mechanism is selectively engaged by the at least one computing device.

16. The system of claim 14, wherein the body further contains a power source.

17. The system of claim 14, wherein the reinforcement element is welded to the lid along a full length of the first edge of the lid.

18. The system of claim 14, wherein the contact element is welded to the reinforcement element on both longitudinal sides of the window.

19. The system of claim 14, wherein the window is asymmetrical in a transverse direction relative to a longitudinal direction of the contact element.

20. A system for remote security, the system comprising:
a trailer;
a storage box supported by the trailer, the storage box including:
a body contained at least one computing device,
a lid movable relative to the body at a first edge of the lid,
a striker affixed to the lid proximate to the first edge, wherein the striker includes:
a contact element, and
a reinforcement element coupled to the lid, wherein the contact element is positioned between the reinforcement element and the lid and at least a portion of the contact element is positioned within a window in the reinforcement element, and
a latch mechanism connected to the body and configured to selectively engage with the contact element;
a mast connected to the trailer or the storage box at a first end of the mast; and
a head unit supported by the mast at a second end of the mast, wherein at least one electronic component of the head unit is in data communication with the at least one computing device of the storage box.
